(19) United States
(12) Patent Application Publication
(10) Pub. No.: US 2023/0183931 A1
(43) Pub. Date: Jun. 15, 2023

(54) PORTABLE BOOM GATE APPARATUS

(71) Applicant: ARROWES IP HOLDINGS PTY LTD, Red Hill Brisbane (AU)

(72) Inventors: Daniel TANIOUS, Red Hill Brisbane (AU); William Patrick Patton RIGBY, Red Hill Brisbane (AU); Chunbin ZHANG, Red Hill Brisbane (AU)

(21) Appl. No.: 17/916,573

(22) PCT Filed: Apr. 6, 2021
(86) PCT No.: PCT/AU2021/050314

§ 371 Date: Oct. 1, 2022

(30) Foreign Application Priority Data
Apr. 2, 2020 (AU) 2020901026
Sep. 4, 2020 (AU) 2020903173
Sep. 15, 2020 (AU) 2020903295

(51) Int. Cl. E01F 13/06; B60R 9/02

(52) U.S. Cl. CPC E01F 13/06; B60R 9/02

(57) ABSTRACT

The invention resides in a portable boom gate apparatus comprising a support member having an attachment portion; an elongate member pivotably connected to the support member; and an actuator adapted to pivot the elongate member. The present invention alleviates at least some of the issues associated the presently available boom gates.

### FIELD OF THE INVENTION

The present invention relates to the field of traffic management. More particularly, the invention relates a boom gate apparatus. Even more particularly, the invention relates to, but is not limited to, a portable boom gate apparatus.

### BACKGROUND TO THE INVENTION

Any reference to background art herein is not to be construed as an admission that such art constitutes common general knowledge in Australia or elsewhere.

Roadworks and/or other construction activities can require management of traffic flow. In this regard, breaks in traffic flow may be required to complete certain tasks. As such, management of traffic is required for both the safety of construction workers and passing motorists.

Presently, a solution to this issue is the provision of a boom gate. Boom gates can deter and/or prevent vehicles from entering a particular area. However, prior art boom gates can be difficult, cumbersome and/or time consuming to install. Obviously, this can be undesirable as traffic management may be required at short notice. Furthermore, portable boom gates are generally required to be heavy to ensure that do not topple over.

It would be advantageous to alleviate one or more of the above problems or to at least provide the consumer with a commercial alternative to the presently available options.

### SUMMARY OF THE INVENTION

In a first form, although it need not be the only or indeed the broadest form, the invention resides in a portable boom gate apparatus comprising:

a support member having an attachment portion;

an elongate member pivotably connected to the support member; and

an actuator adapted to pivot the elongate member.

In one embodiment, the attachment portion is for attachment to a stable movable assembly. In some embodiments, the stable movable assembly is a vehicle, a tray or a tripod.

In an embodiment, the actuator is adapted to pivot the elongate member to a GO configuration, a STOP configuration or a storage configuration.

In embodiments, the attachment portion is complementary to a second attachment portion. In one embodiment, the attachment portion is removably attachable to the second attachment portion. In an embodiment, a tray comprises the second attachment portion.

In one embodiment, a vehicle comprises the tray. In one embodiment, the tray is integrated with the vehicle.

In another embodiment, the tray is removably attachable to a vehicle. In an embodiment, the tray is in the form of a trailer that is removably attachable to a vehicle.

In one embodiment, the elongate member comprises a first securing portion.

In an embodiment, the portable boom gate apparatus further comprises a second elongate member comprising a second securing portion. In a further embodiment, the second securing portion is removably attachable to the first securing portion. In an embodiment, the second elongate member is removably attachable to the elongate member. In one embodiment, the first securing portion is complementary to the second securing portion.

In one embodiment, the support member is removably attached to the tray.

In an embodiment, the tray comprises a frame. In a further embodiment, the frame is pivotably attached, or removably attached, to the tray.

In one embodiment, the frame is a pivotable frame. In a further embodiment, the pivotable frame is directly mounted to the tray at one end thereof. In yet a further embodiment, the support member is mounted, or removably attached, to the distal end of the pivotable frame.

In one embodiment, the elongate member is removably attachable to a receiving member connected to the actuator. In an embodiment, the receiving member comprises a first portion connecting a second portion to the actuator. In one embodiment, the second portion is hingedly connected to the first portion. In one embodiment, the second portion is hingedly connected to the first portion such that application of force on the second portion results in rotation of the second portion relative to the first portion. In one embodiment, the first portion comprises a first connecting portion that is complementary to a second connecting portion of the second portion. The first connecting portion and the second connecting portion retain the first portion and the second portion in the substantially the same axis.

In one embodiment, the support member further comprises an object detection sensor. In an embodiment, the object detection sensor is placed in vicinity of the second portion when in the crash configuration.

In one embodiment, the tripod is a tripod assembly. In an embodiment, the tripod assembly is for mounting traffic signage and equipment. In some embodiments, the tripod assembly comprises a central column having three or more brackets located along an outer surface of the column, and three leg assemblies such that each leg assembly is positioned between spaced apart side walls in a corresponding bracket and configured to pivot between a collapsed closed position and extended open position within side walls of the bracket. In embodiments, the tripod assembly further comprises one or more sandbag engaging members. In an embodiment, the sandbag engaging member is pivotably connected to a leg assembly.

In a second form, although it need not be the only or indeed the broadest form, the invention resides in a portable traffic management system comprising:

a portable boom gate apparatus of the first form; and

a portable traffic signal assembly.

The portable boom gate apparatus is as substantially described for the first form.

In one embodiment, the first and/or second form may further comprise a remote control. The remote control may be in wireless communication with the portable boom gate apparatus and/or the traffic signal assembly. The remote control is configured to send a GO configuration signal or a STOP configuration signal to the portable traffic signal assembly, and/or is configured to send a GO configuration signal, a STOP configuration signal or a storage configuration signal to the portable boom gate assembly.

In another form, the invention also resides in a method of operating a portable boom gate apparatus, the method including the steps of:

providing a portable boom gate apparatus comprising a support member having an attachment portion, an elongate member pivotably connected to the support member, and an actuator adapted to pivot the elongate member;

attaching a second elongate member to the first elongate member; and

configuring the portable boom gate apparatus in an operable mode between a GO configuration and a STOP configuration,

to thereby operate the portable boom gate apparatus,

The portable boom gate apparatus is as substantially described for the first form or second form.

The various features and embodiments of the present invention referred to in the individual sections above and in the description which follows apply, as appropriate, to other sections, mutatis mutandis. Consequently features specified in one section may be combined with features specified in other sections as appropriate.

Further features and advantages of the present invention will become apparent from the following detailed description.

### BRIEF DESCRIPTION OF THE DRAWINGS

To assist in understanding the invention and to enable a person skilled in the art to put the invention into practical effect, embodiments of the invention will be described by way of example only with reference to the accompanying drawings, in which:

FIG. 1a shows a boom gate apparatus in a storage configuration;

FIG. 1b shows the boom gate apparatus of FIG. 1 in a STOP configuration;

FIG. 1c shows the boom gate apparatus of FIG. 1 in a GO configuration;

FIG. 2a-e show another embodiment of a portable boom gate apparatus;

FIG. 3a-d show a number of views of an embodiment of a portable boom gate apparatus;

FIG. 4a-b show a portable traffic management system;

FIG. 5 shows an embodiment of a portable traffic signal assembly;

FIG. 6a-cshows a boom gate in a storage configuration (FIG. 6a), a STOP configuration (FIG. 6b) and a GO configuration (FIG. 6c);

FIG. 7a-e show another embodiment of a portable boom gate apparatus;

FIG. 8a-d show a number of views of a number of view of an embodiment of a portable boom gate apparatus;

FIG. 9 shows an exploded view of the embodiment of FIG. 8a-d;

FIG. 10a-d shows another embodiment of a boom gate apparatus without an elongate member;

FIG. 10e-f show the boom gate apparatus of FIG. 10a-d with an elongate member in a STOP configuration and a crash configuration, respectively;

FIG. 11a-cshow the attachment of a base and a lower end of the support member;

FIG. 12 shows an enlarged view of the tripod assembly in a number of positions; and

FIG. 13 shows another embodiment of a tripod assembly.

### DETAILED DESCRIPTION OF THE INVENTION

Embodiments of the present invention reside primarily in a portable boom gate apparatus. Accordingly, the apparatus, assembly, system and/or method steps have been illustrated in concise schematic form in the drawings, showing only those specific details that are necessary for understanding the embodiments of the present invention so as to not obscure the disclosure with excessive detail that will be readily apparent to those of ordinary skill in the art having the benefit of the present description.

In this specification, adjectives such as first and second, left and right, and the like may be used solely to distinguish one element or action from another element or action without necessarily requiring or implying any actual such relationship or order.

Words such as “comprises” or “includes” are intended to define a non-exclusive inclusion, such that an apparatus, assembly, system or method that comprises a list of elements does not include only those elements but may include other elements not expressly listed, including elements that are inherent to such an apparatus, assembly, system or method.

As used herein, the term ‘about’ means the amount is nominally the number following the term ‘about’ but the actual amount may vary from this precise number to an unimportant degree.

As used herein, the term ‘tray’ refers to a vehicle tray, that is, a tray for a vehicle. It will be appreciated that the ‘tray’ may be integrated with the vehicle. However, it will also be appreciated that the term ‘tray’ may also be a trailer that is removably attachable to a vehicle. In one embodiment, the tray is a tray integrated with a vehicle. In another embodiment, tray is a trailer that is removably attachable to a vehicle.

As mentioned above, management of traffic flow may be required to deter and/or prevent traffic into a particular area. This may be required for the safety of construction workers and/or motorists. A present solution to this issue is the provision of a boom gate. However, presently available boom gates can be difficult, cumbersome and/or time consuming to install.

The present invention is predicated on, at least, the finding that a portable boom gate apparatus can be provided that alleviates one or more of these issues.

In a first form, although it need not be the only or indeed the broadest form, the invention resides in a portable boom gate apparatus comprising:

a support member having an attachment portion;

an elongate member pivotably connected to the support member;

an actuator for pivoting the elongate member.

The present invention allows a portable boom gate apparatus to be removably attachable to a stable movable assembly. In one embodiment, the stable movable assembly is a tray. This attachment is preferably stable to ensure the correct orientation of the portable boom gate apparatus. As such, a vehicle comprising a tray or a vehicle removably attached to a tray may be driven directly to a location in need of management of traffic flow. The operator may drive the vehicle to the desired location, park the vehicle or leave the tray, and simply activate the portable boom gate apparatus to control the flow of traffic. This alleviates the issue of the boom gate being difficult, cumbersome and/or time consuming to install because the portable boom gate apparatus can simply be driven to the desired location and activated. It will be appreciated by the person skilled in the art that the present invention has been described in relation to a tray for ease of description, and that the present invention could also be removably attached to other stable movable assemblies. Non-limiting examples of these stable movable assemblies include vehicles, vehicle trays, tripods, trailers and cages (e.g., cages that are built on vehicle trays).

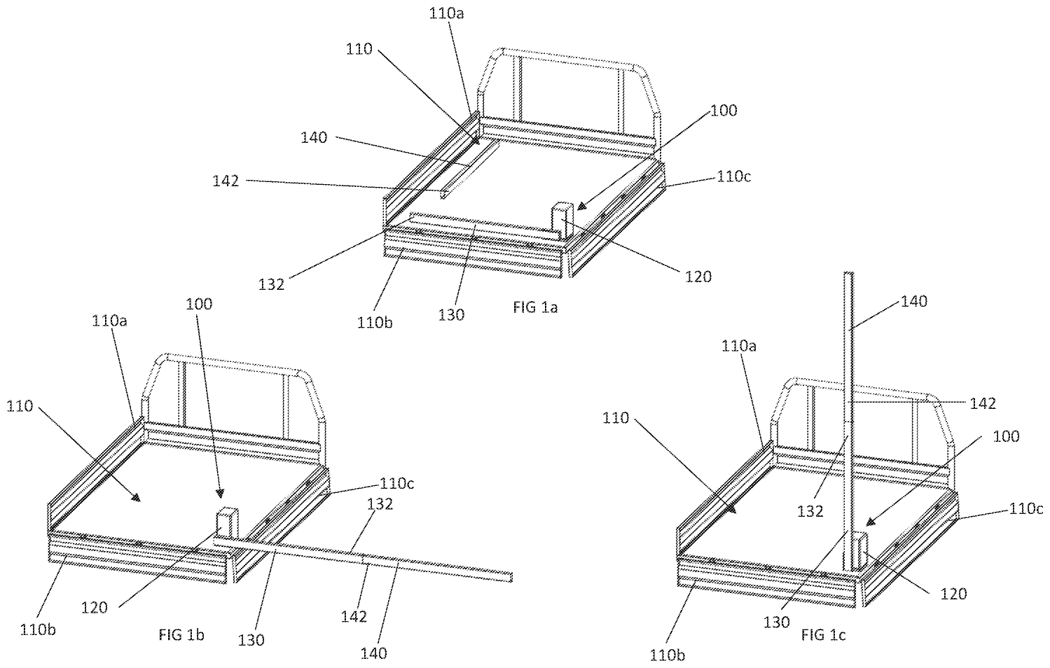

Referring to FIG. 1a, a portable boom gate apparatus 100 is removably attached to a tray 110. The portable boom gate apparatus 100 is shown in a storage configuration. In this regard, the storage configuration is the configuration in which the portable boom gate apparatus 100 is transported or otherwise not in use. The portable boom gate apparatus 100 comprises a support member 120. In this embodiment, the support member 120 is removably attachable to a tray 110. Preferably, the attachment is stable to maintain the correct orientation of the portable boom gate apparatus 100. In this regard, the support member 120 comprises an attachment portion (not shown) and the tray 110 comprises a second attachment portion (not shown). The attachment portion is complementary to the second attachment portion. The support member 120 may be stably removably attachable to the tray 110 by virtue of the attachment portion and the second attachment portion.

The portable boom gate apparatus 100 further comprises an elongate member 130 that is pivotably connected to the support member 120. In one embodiment, the elongate member 130 is removably pivotably connectable to the support member. The elongate member 130 may be connected to the support member 120 by an actuator (not shown). The actuator is adapted to pivot the elongate member 130 between at least an upright position (GO configuration), a horizontal position (STOP configuration) and another horizontal position (storage configuration). In one embodiment, the portable boom gate apparatus is configured to be in a GO configuration, a STOP configuration and/or a storage configuration. The portable boom gate assembly may be operated in the GO configuration and STOP configuration when managing the flow of traffic. Shown in FIG. 1a, the portable boom gate apparatus 100 further comprises a second elongate member 140. The second elongate member 140 is removably attachable to the elongate member 130. The second elongate member 140 extends the reach of the pivotable boom gate. The second elongate member 140 may comprise a second securing portion 142 that is removably attachable to a first securing portion 132. The first securing portion 132 is located on the distal end of the elongate member 130. The second elongate member 140 may be stored or otherwise retained by the tray 110. In one embodiment, the elongate member may define a bore along the longitudinal axis thereof. The second elongate member may be received within said bore. The second elongate member may be in a sleeved connection with the elongate member. The second elongate member may be slidable relative to the elongate member. The first securing portion 132 is complementary to the second securing portion 142. Non-limiting examples of the first securing portion and second securing portion include wing nuts, hex nuts, latched or a pin joint. The person skilled in the art will appreciate that the above list is not an exhaustive list and that other examples known in the art could be utilized as the first securing portion and the second securing portion.

In one embodiment, the length of the elongate member is shorter than the inner width of the tray. This allows for the elongate member (in the storage configuration) to easily fit within the tray during transport. This advantageously allows for the portable boom gate assembly to be easily transport from one location to another location. A tray typically has a width of about 2.5 m. The elongate member suitably has a length of less than about 2.5 m, more suitably less than 2 m, and even more preferably less than 1.5 m. However, it will be appreciated that the dimensions of the elongate member can be easily adapted to the size of the tray.

In one embodiment, the second attachment portion is located near a corner of the tray. As shown in the figures, the second attachment portion is located adjacent the right rear corner of the tray. However, it will be appreciated that the portable boom gate apparatus may be located anywhere on a tray and this can be achieved by simply changing the locating of the second attachment portion thereon.

The provision of the portable boom gate apparatus that is detachable allows the portable boom gate apparatus to be lighter. This results in less material being required to form the portable boom gate apparatus. Typically, portable boom gates are required to be heavy to ensure that they have sufficient inertia to prevent from toppling. However, attaching a portable boom gate apparatus to a heavy structure alleviates this issue because the weight of the structure can be utilized. As such, in the circumstance of a tray, the weight of the tray stabilizes the portable boom gate apparatus.

The tray 110 may suitably be integrated with a vehicle (not shown). Alternatively, the tray 110 may be in the form of a trailer that is removably attachable to a vehicle (not shown).

Referring to FIG. 1b, portable boom gate apparatus 100 is shown in an operable configuration and in the horizontal position (STOP configuration). The portable boom gate apparatus 100 comprises a support member 120 having an attachment portion (not shown). In this embodiment, the support member 120 is removably attachable to a tray 110. The portable boom gate apparatus 100 further comprises an elongate member 130 that is pivotably connected to the support member 120. The elongate member 130 may be connected to the second elongate member 140 by virtue of the first securing portion 132 being complementary to the second securing portion 142.

The tray 110 is placed adjacent a road. In this configuration, vehicles on the adjacent road are impeded or prevented from travelling on said road by the elongate members. It will be appreciated that the portable boom gate apparatus 100 may comprise any number of elongate members connected to one another. The person skilled in the art will appreciate that each elongate member may comprise a securing portion on each end thereof which can be connected to a complementary securing portion of another elongate member. The person skilled in the art will appreciate that the number of elongate members utilized in the present invention could be any one of 1, 2, 3, 4, 5, 6, 7, 8,9 or 10.

Referring to FIG. 1c, portable boom gate apparatus 100 is shown in an operable configuration and in the upright position (GO configuration). In this configuration, vehicles on the adjacent road are not impeded or prevent from travelling on said road. As per FIG. 1b, the elongate member 130 may be connected to the second elongate member 140 by virtue of the first securing portion 132 being complementary to the second securing portion 142.

The actuator (not shown) is adapted to pivot the elongate member 130, and optionally the connected second elongate member 140, into three possible configurations: a storage configuration (where the first elongate member is horizontally located above the base of the tray; FIG. 1a), a STOP configuration (where the first elongate member and optionally the second elongate member are in a horizontal position across an adjacent road; FIG. 1b), and a GO configuration (where the first elongate member and optionally the second elongate member are in an upright position; FIG. 1c). It will be appreciated that GO configuration and STOP configuration are the operable configurations. It should be appreciated that the actuator is adapted to move the elongate member over 180° in an upward arc relative the ground. This 180° movement moves from the storage configuration (horizontal position) through to the STOP configuration (other horizontal position) while passing through the GO configuration (upright position). In the operable configuration, the actuator is only operable between the GO configuration or STOP configuration.

Referring to FIGS. 1a-c, the tray 110 suitably comprises one or more walls. In the embodiment shown, the tray 110 comprises three walls 110a, 110b and 110c. One or more of these walls may be pivotably connected to the tray 110. These walls may be hingedly connected to the tray 110, and may be pivoted such that they ‘hang’ from the tray 110. This allows the support member 120 to have shorter dimension because it is not required to have the actuator and elongate member 130 at a height above the wall. As such, the support member 120 may be more compact and this is advantageous from an environmental view point as less material is required to form the structure. In the embodiment shown, walls 110a, 110b and 110c are all hingedly connected to the tray 110. However, only walls 110b and 110c are shown to ‘hang’ from the tray. This also allows for the elongate member to be connected near the base of the support member, and this advantageously improves the centre of gravity of the portable boom gate apparatus. In one embodiment, the elongate member is connected to the support member adjacent the attachment portion.

The portable boom gate apparatus described herein may further comprise a power source. In one embodiment, the power source is a battery. The battery may be connected to the actuator to provide power thereto. In some embodiments, the battery may be replaced with solar panels or used in combination with solar panels. In an embodiment, the battery is a rechargeable battery. In one embodiment, the power source may be an engine of the vehicle or connected to an engine of the vehicle.

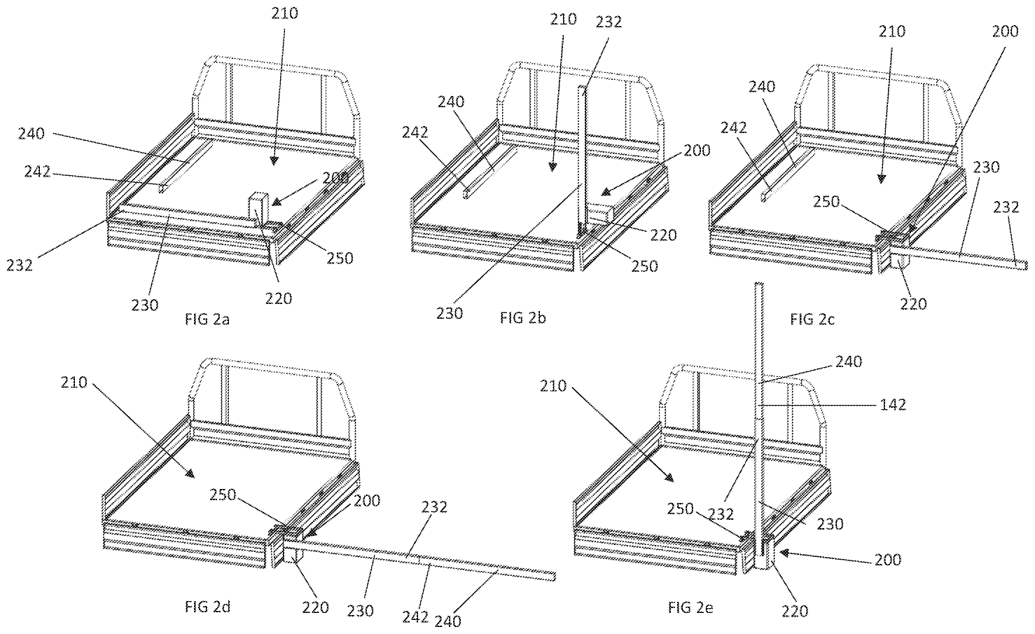

Shown in FIG. 2a-2e is another embodiment of a portable boom gate apparatus 200. The portable boom gate apparatus 200 comprises a support member 220 having an attachment portion (not shown). The support member 220 is removably attachable to a tray 210. The portable boom gate apparatus 200 further comprises an elongate member 230 that is pivotably connected to the support member 220. The elongate member 230 may be connected to the support member 220 by an actuator (not shown). The actuator is configured to pivot the elongate member 230 between at least an upright position (GO configuration), a horizontal position (STOP configuration) and another horizontal position (storage position). Shown in FIG. 2a, the portable boom gate apparatus 200 further comprises a second elongate member 240. The second elongate member 240 may be stored or other retained by the tray 210. The second elongate member 240 is removably attachable to the elongate member 230. The second elongate member 240 may comprise a second securing portion 242 that is removably attachable to a first securing portion 232. The first securing portion 232 is located on the distal end of the elongate member 230. The first securing portion 232 is complementary to the second securing portion 242.

One difference between the portable boom gate apparatus 200 of FIG. 2a-e and the portable boom gate apparatus 100 of FIG. 1a-cis that portable boom gate apparatus 200 is provided with a frame 250. In one embodiment, the frame is a pivotable frame. The pivotable frame 250 is mounted, or remotably attached to, on tray 210. In this regard, pivotable frame 250 is mounted or removably attached to the tray 210 at one end thereof and the support member 220 is mounted or removably attachable to the distal end thereof. The pivotable frame 250 is pivotable around the juncture of the pivotable frame 250 and the tray 210 (as shown in FIGS. 2b and 2c). The pivotable frame 250 may suitable comprise a pair of railings, an end of each rail being pivotally attached to the tray 210. Suitably, the pair of railings are substantially parallel. The pivotable frame 250 may also comprise a plurality of transverse bars attached to each rail to provide further strength thereto. These bars and the end of each rail may be attached to the support member 220.

In use, the pivotable frame 250 may be pivoted such that the support member 220 attached thereto hangs over an edge of the tray 210 (as shown in FIG. 2c-2e). The elongate member 230 and attached second elongate member 240 (via. the first securing portion 232 and the second securing portion 242) may then be configured in the GO configuration or STOP configuration. As can be seen, the use of a pivotable frame 250 allows the elongate member 230 to be closer to the ground, and thus alleviates the issue of low clearance vehicles being able to circumvent the portable boom gate apparatus 200. This also extends the ‘reach’ of the elongate member 230 and second elongate member 240 across the adjacent road.

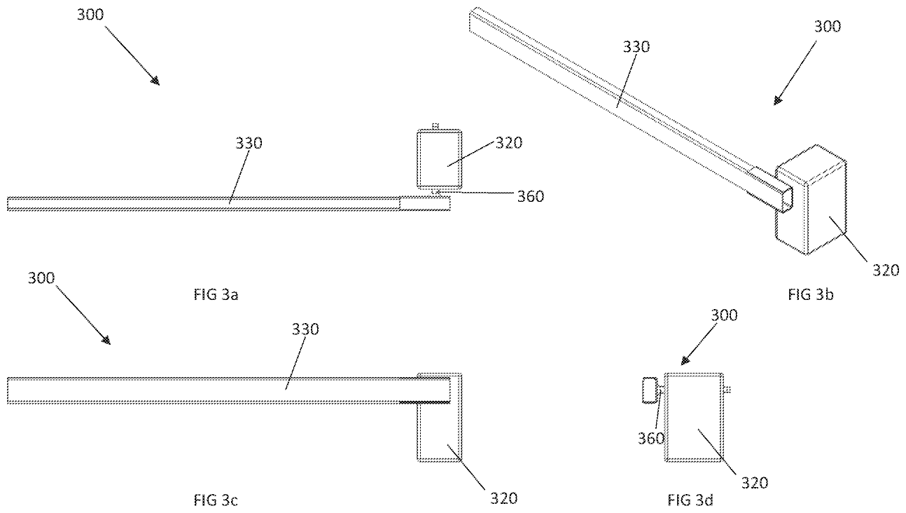

FIGS. 3a-3d show a number of views of an embodiment of a portable boom gate apparatus 300 in a horizontal position (STOP configuration). The portable boom gate apparatus 300 comprises a support member 320 that may be removably attachable to part of a tray (not shown). In this embodiment, the portable boom gate apparatus 300 comprises a single elongate member 330. The portable boom gate apparatus 300 further comprises an actuator 360 which is connected to the elongate member 330 and the support member 320. The actuator 360 is adapted to pivot or move the elongate member 320 between at least an upright position (GO configuration), a horizontal position (STOP configuration), and another horizontal position (storage configuration).

In a further form, the invention resides in a portable traffic management system comprising:

a portable boom gate apparatus comprising a support member having an attachment portion, an elongate member pivotably connected to the support member, and an actuator adapted to pivot the elongate member; and

a portable traffic signal assembly.

The portable boom gate apparatus is as substantially described hereinabove.

The portable boom gate apparatus may be in communication with the portable traffic signal assembly. In one embodiment, the portable boom gate apparatus is in wireless communication with the portable traffic signal assembly.

In another embodiment, the portable boom gate apparatus may be in direct communication with the portable traffic signal assembly.

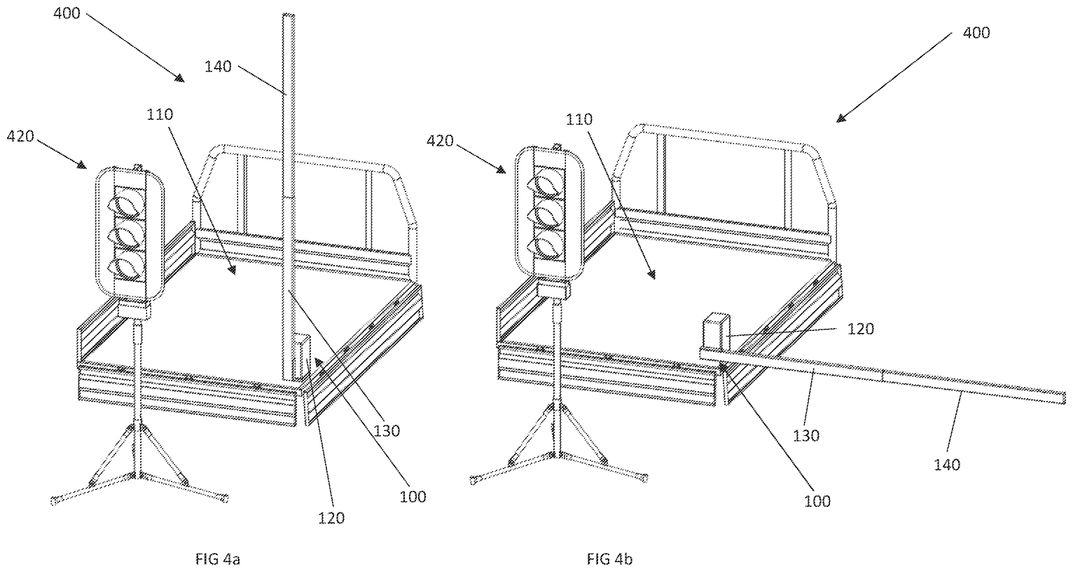

The portable traffic signal assembly is configured to show either a green light (GO configuration) or a red light (STOP configuration) or a yellow light (intermediate configuration). The portable traffic signal assembly may send a signal to the portable boom gate apparatus relating to the configuration thereof. In response, the portable boom gate apparatus changes configuration accordingly to remain consistent with the portable traffic signal assembly. Shown in FIG. 4a is an embodiment of the traffic management system in a GO configuration. The traffic management system 400 comprises a portable boom gate apparatus 100 removably attached to a tray 110 (as described hereinabove for FIG. 1c) and a portable traffic signal assembly 420. The portable boom gate apparatus 100 is in communication with the portable traffic signal assembly 420. The portable boom gate apparatus 100 may be in wireless communication or in direct communication with the portable traffic signal assembly 420. In this figure, the portable traffic signal assembly 420 and the portable boom gate apparatus 100 are in the GO configuration (the elongate member and the second elongate member in the upright position, and the portable traffic signal assembly is showing a green light).

Shown in FIG. 4b is the traffic management system 400 in a STOP configuration. The traffic management system 400 comprises a portable boom gate apparatus 100 removably attached to a tray 110 (as described hereinabove for FIG. 1b) and a portable traffic signal assembly 420. When the portable traffic signal assembly 420 changes to a STOP configuration, a signal is sent to the portable boom gate apparatus 100. In response to this signal, the portable boom gate apparatus 100 changes configuration to match the configuration of the portable traffic signal assembly 420. The portable traffic signal assembly and the portable boom gate apparatus are in the STOP configuration (the elongate member and the second elongate member in the horizontal position above the road, and the portable traffic signal assembly is showing a red light).

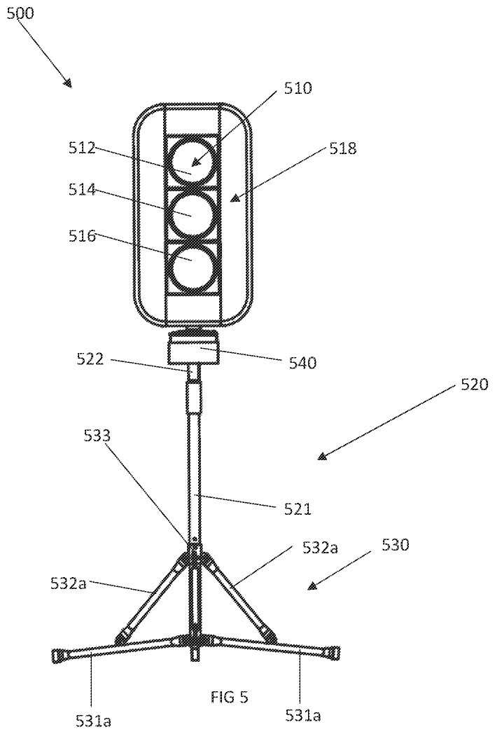

Shown in FIG. 5 is one embodiment of a portable traffic signal assembly 500. The portable traffic signal assembly 500 may comprise a support assembly 520 adapted to receive the traffic lantern 510. The support assembly 520 is adapted to releasably receive the traffic lantern 510. Preferably, the support assembly 520 is an elongate support assembly. More preferably, the support assembly 520 is a collapsible support assembly.

The support assembly 520 further comprises an upper support member 522 and a lower support member 521. The support assembly 520 further comprises a base assembly 530.

The base assembly 530 includes three support legs 531a, three stays 532a and a fastening collar 533. The fastening collar 533 is located about the lower support member 521 of the support member.

The support legs 531a are pivotally coupled to an end of the lower support member 521 and are spaced about the lower support member 521 at approximately 120° relative to each other to provide a stable support. While the embodiments herein have been described as having three (3) support legs, it will be appreciated that additional support legs could be included to further improve stability.

Each leg 531a includes a stay 532a, one end of which is pivotally coupled to the fastening collar 533. At an opposite end, each stay is pivotally coupled to the centre of its respective leg.

The support legs 531a can be folded vertically by moving the feet of the support legs 531a and the fastening collar 533 along the lower support member 521. The fastening collar 533 has a fastening screw (not shown) or other suitable mechanism for locking the fastening collar 533 in place along the lower support member 521.

An end of the upper support member 522 is received within an end of the lower support member 521 to couple the upper and lower support members 522, 521 together.

The feet comprise hollow cylindrical portions which may receive pegs or other suitable tie-down devices used to secure the base assembly to the ground or a supporting surface.

A battery may also be located in a receptacle 540 connected to the upper support member 522. The battery may be connected to the traffic lantern 510 to provide power thereto. In some embodiments, the battery may be replaced with solar panels or used in combination with solar panels. In an embodiment, the battery is a rechargeable battery.

In one embodiment, one or more of the stays may include two telescoping members: an outer member and an inner member. The inner member is received within the outer member and, in use, one of the adjustable stays can be lengthened by extending the inner member from the end of the outer member or shortened by retracting the inner member to be located within the outer member. In order to lock the adjustable stay in a particular position, the inner member may include a number of apertures which can be aligned with an aperture of the outer member and a locking pin may be inserted through the aligned apertures to lock the stay in place.

The telescoping stay and adjustable length allows the support assembly to be placed on uneven surfaces and still provide the center support member in a substantially vertical/upright orientation so that the portable traffic light assembly can be directed toward traffic and vehicles.

The support assembly is as substantially described in Australian Innovation Patent No. 2020100193 and the contents of which is incorporated herein by reference in its entirety.

In one embodiment, the portable traffic signal assembly comprises a traffic lantern. In an embodiment, the traffic lantern comprises a red light 512 and a green light 516. In a further embodiment, the traffic lantern may further comprises a yellow light 514. The yellow light 514 may be adapted to display an amount of time (numeral form). In one embodiment, the amount of time is a countdown. The countdown may be divided into a number of integers. For example, in the case of the amount of time available prior to actuation of a green light is 60 seconds, then the countdown may commence from 9 to 0 in intervals of 6 seconds. In one embodiment, the countdown may begin at 9 and end at 0. The countdown may be used to give an indication of the amount of time before a red light. Similarly, in the case of the amount of time available prior to actuation of a red light is 60 seconds, then the countdown may commence from 9 to 0 in intervals of 6 seconds. The person skilled in the art will appreciate that other interval times and countdown numbers can be utilized. It will be appreciated that the red, yellow and green lights can be formed of any light emitting devices known to the person skilled in the art. A non-limiting example of a light emitting device is a LED light.

The yellow light of the traffic lantern may be adapted to display an amount of time. In one embodiment, the amount of time may be the amount of time available prior to actuation of a red light. In another embodiment, the amount of time may be the amount of time available prior to actuation of a green light.

This provides motorists with an indication of how much time is available before a red light appears. This alleviates the issue of a motorist being unsure as to the amount of time they have before a green light becomes a red light. As such, the motorist is provided with forewarning of an impending light change and may slow down or maintain speed depending on the amount of time available. This alleviates the issue of a motorist being caught in a situation where the motorist is unsure as to whether they should stop or proceed. Alternatively, the yellow light may also provide motorists with an indication of how much time is available before a green light appears. In one embodiment, the yellow light indicates the much time available prior to a red light. In another embodiment, the yellow light indicates the amount of time available prior to a green light. In one embodiment, the yellow light is operated at the same time as the red light. In another embodiment, the yellow light is operated at the same time as the green light.

The portable boom gate apparatus may further comprise a remote control. The remote control is suitably in wireless communication with the actuator. The remote control may issue signals to actuate the actuator of the portable boom gate apparatus. The remote control may issue a signal such that the actuator is in the GO configuration, the STOP configuration or the storage configuration.

In the instance of the traffic management system, the remote control may also be in wireless communication with the portable traffic signal device. The portable traffic signal device may change configuration with respect to the signal received from the remote control (GO configuration or STOP configuration). The portable traffic signal device may then send a signal to the portable boom gate apparatus of the configuration thereof, and the portable boom gate apparatus then changes configuration to match said configuration. In one embodiment, the remote control comprises a waterproof housing. In one embodiment, the remote control can be utilized to send a GO configuration signal or a STOP configuration signal to the portable traffic signal device and/or the portable boom gate apparatus. The remote control advantageously allows an operator to control the flow of traffic remotely.

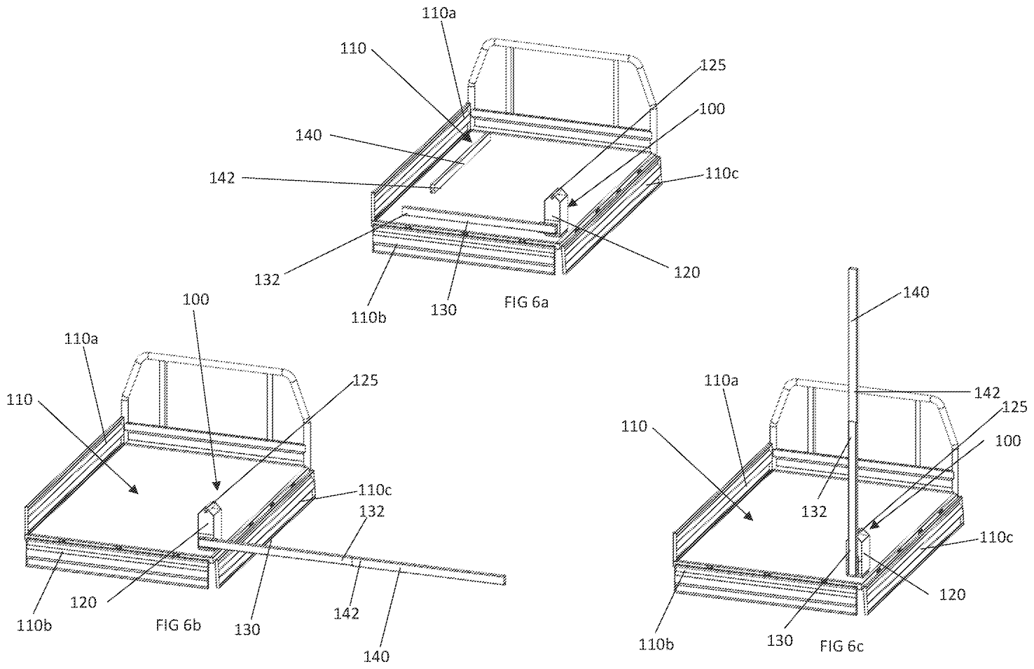

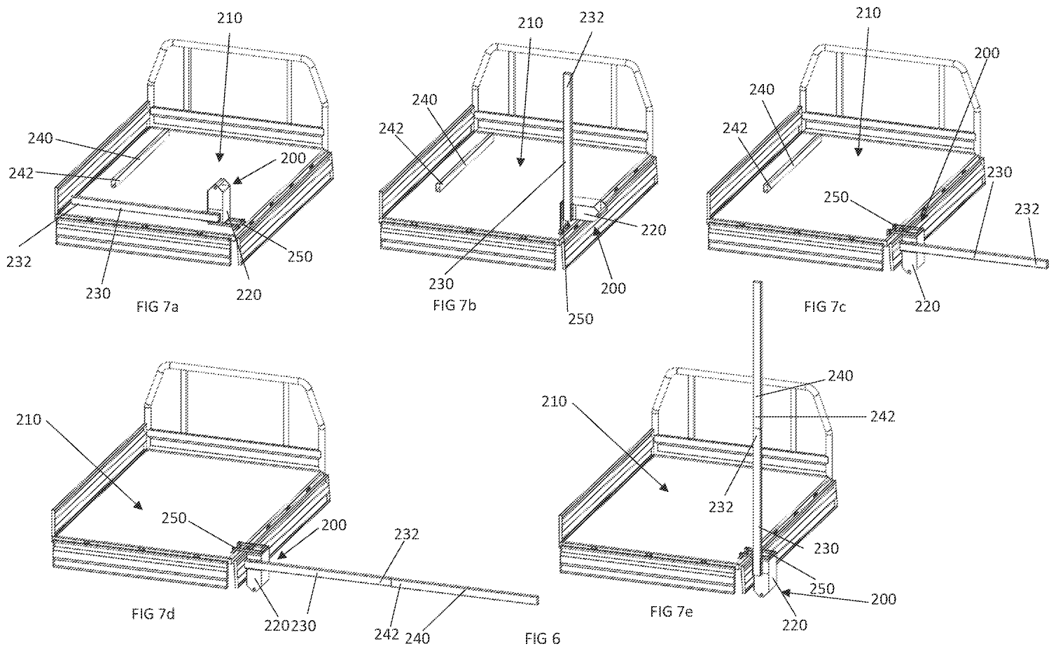

Shown in FIGS. 6a-cand 7a-e are other embodiment of the portable boom gate apparatus. The portable boom gate apparatus shown in FIG. 6a-cis similar to that described in FIGS. 1a-c. For ease of description, the same numbering has been utilized as per the embodiment shown in FIG. 1a-c. A difference between the embodiment of FIGS. 1a-cand the embodiment of FIGS. 6a-cis the provision of a handle 125 on the support member 120. As shown, the distal end of the support member 120 comprises a handle 125. The handle 125 is in the form a bar that can be grasped by an operator to facilitate movement of the support member 120 to different locations. This allows for the detached support member 120 to be moved easily from location to location.

Shown in FIGS. 7a-e is another embodiment of the portable boom gate apparatus. The portable boom gate apparatus shown in FIGS. 7a-e is similar to that described in FIGS. 2a-e. For ease of description, the same numbering has been utilized as per the embodiment shown in FIG. 2a-e. Similarly, a difference between the embodiment of FIGS. 2a-e and FIGS. 7a-e is the provision of a handle 225 on the support member 220. The support member 220 comprises a handle 225 at the distal end thereof. The handle 225 allows for the support member 220 to be easily transported.

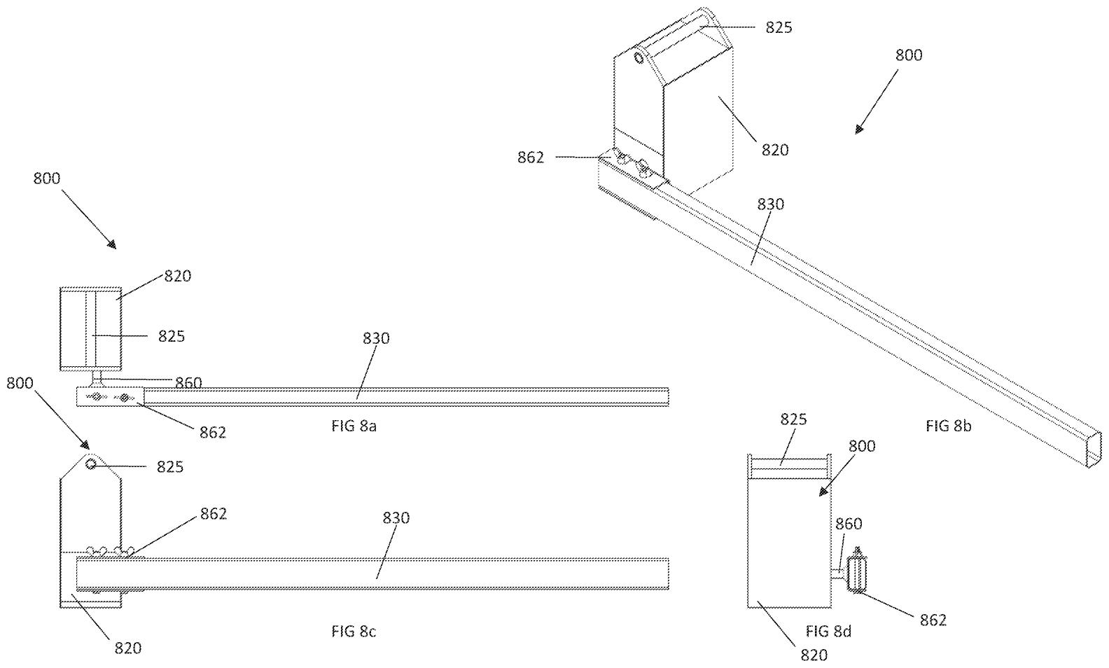

FIGS. 8a-d show a number of views of an embodiment of a portable boom gate apparatus 800 in a horizontal position. The portable boom gate apparatus 800 comprises a support member 820 that may be removably attachable to part of a tray (not shown). The support member 820 comprises a handle 825. In this embodiment, the portable boom gate apparatus 800 comprises a single elongate member 830. The elongate member 830 may be removably attachable to support member 820. The portable boom gate apparatus 800 further comprises an actuator 860 which is connected to the elongate member 830 and the support member 820. The actuator may comprise a receiving member 862. The receiving member 862 is adapted to receive the elongate member 820. The elongate member 820 may be fastened to the receiving member 862. The receiving member 862 may comprise one or more apertures. The elongate member 830 may also comprise one or more apertures (not shown) that align with the one or apertures of the receiving member 862. The elongate member 830 may be fastened to the receiving member by methods known to the person skilled in the art. Non-limiting examples of such methods are hex nuts, wing nuts and bolts. The actuator 860 is adapted to pivot or move the elongate member 820 between at least an upright position (GO configuration), a horizontal position (STOP configuration), and another horizontal position (storage configuration). The removability of the elongate member further alleviates the issue of storage. In this regard, the support member and elongate member and/or second elongate member may be stored separately. This is advantageously space efficient.

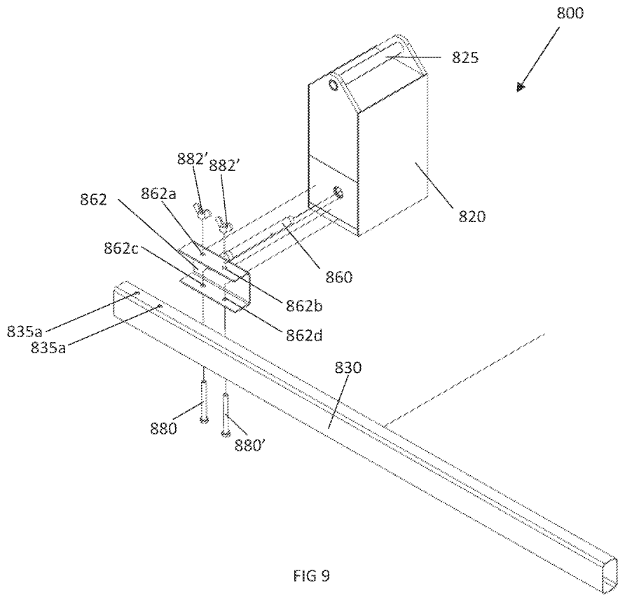

FIG. 9 shows an exploded view of the embodiment shown in FIGS. 8a-d. As shown in this figure, the receiving member 862 comprises one or more aligned apertures 862a, 862b, 862c, 862d. In the embodiment shown, receiving member comprises a pair of aligned apertures (apertures 862a and 862c are aligned, and 862b and 862d are aligned). Elongate member 830 comprises one or more aligned apertures. In the embodiment shown, elongate member 830 comprises a pair of aligned apertures 835a, 835b (only the top apertures are shown, the complementary aligned apertures are located on the underside of the elongate member 830). The apertures of the elongate member 830 are aligned with the apertures of the receiving member 862. When aligned, a fastening device may be inserted therethrough to secure the elongate member to the receiving member. As shown in the FIG. 9, a pair of bolts 880, 880′ and a pair of wing nuts 882, and 882′ can be utilized to secure the elongate member 830 and receiving member 862.

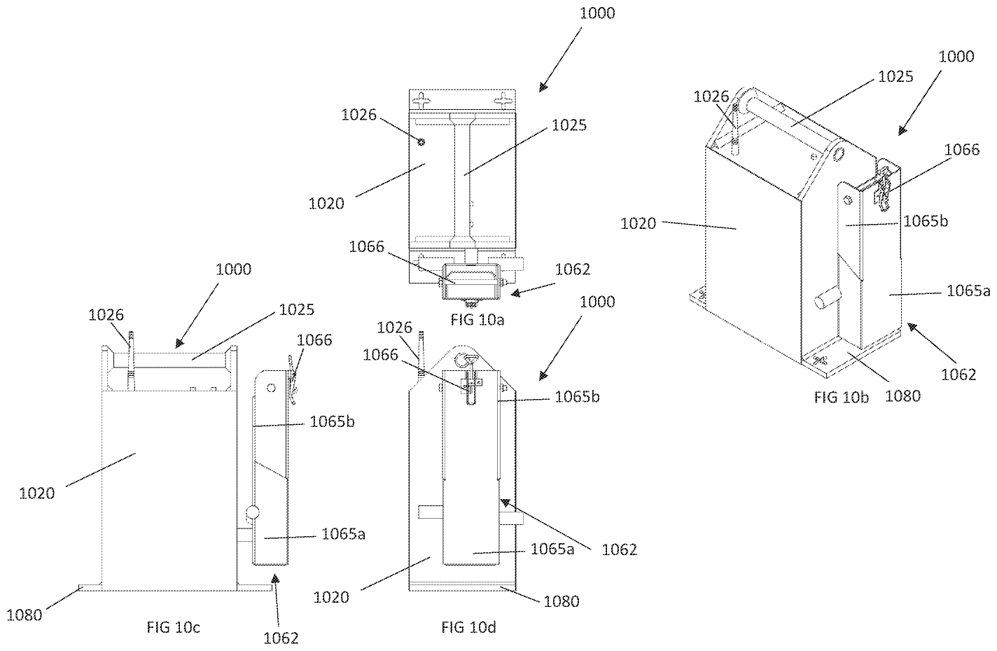

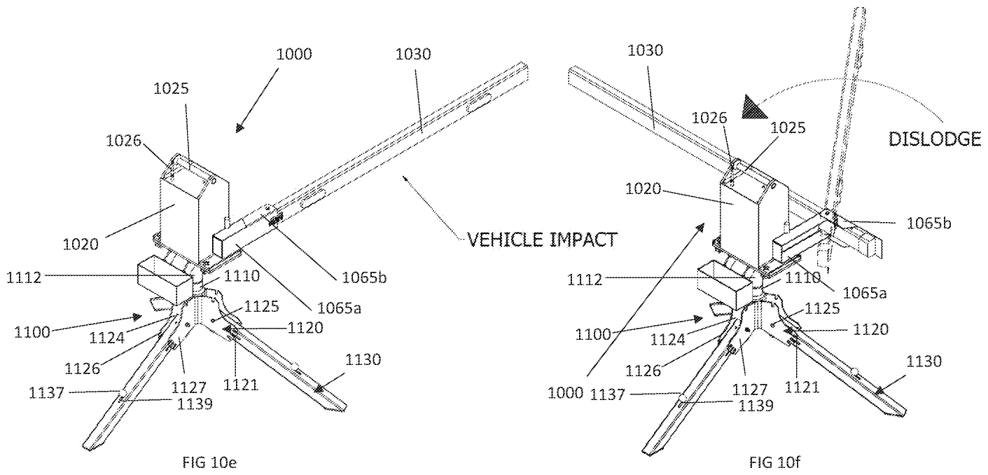

FIG. 10a-d show a number of views of an embodiment of a portable boom gate apparatus 1000 without an elongate member connected to the support member for exemplification purposes. The portable boom gate apparatus 1000 comprises a support member 1020. The support member 1020 comprises a handle 1025. The support member 1020 may be removably attachable to part of a tray (not shown). Furthermore, the support member 1020 may be removably attachable to a tripod (mentioned in more detail hereinafter). In this embodiment, the portable boom gate apparatus 1000 further comprises a remote control antenna 1026 adapted to receive a signal from a remote control.

The portable boom gate apparatus 1000 further comprises an actuator 1060 which is connected to the support member 1020 and a receiving member 1062. In the present embodiment, the receiving member 1062 comprises a first portion 1065a connected to a second portion 1065b. The first portion 1065a is connected to the actuator 1060 and the second portion 1065b. The second portion 1065b is hingedly connected to the first portion 1065 such that the second portion 1065b rotates relative to the first portion 1065a when subjected to force (such as a vehicle running into the elongate member 1030 attached thereto). The first portion 1065a and the second portion 1065b may suitably be retained in substantially the same plane or axis. In this regard, the first portion 1065a comprises a first connecting portion that is complementary to a second connecting portion of the second portion 1065b. The first connecting portion and second connecting portion retain the first portion 1065a and second portion 1065b in substantially the same plane or axis. One or both of the first connecting portion and the second connecting portion may comprise magnetic components that retain this position. In another embodiment, one or both of the first connecting portion and the second connecting portion may comprise a sacrificial component that retains this position. The first connecting portion and the second connecting portion allow for the first portion 1065a and second portion 1065b in substantially the same plane or axis during use. However, when force is applied to the elongate member 1030 attached to the second portion 1065b, the first connecting portion and the second connecting portion decouple

and allows rotation of the second portion 1065b relative to the first portion 1065a.

The second portion 1065b is adapted to removably receive an elongate member 1030. Similar to the embodiments mentioned in FIGS. 1, 2, 6 and 7, the portable boom gate apparatus 1000 may further comprise a second elongate member. The second elongate member is removably attachable to the elongate member 1030. In this regard, the second elongate member may comprise a second securing portion that is removably attachable to a first securing portion. The elongate member 1030 may comprise the first securing portion. Preferably, the elongate member 1030 comprises the first securing portion at a distal end thereof. The first securing portion is complementary to the second securing portion. In this regard, second portion 1065 suitably comprises a clasping mechanism 1066 to securely and removably receive the elongate member 1030. It will be appreciated that the elongate member 1030 is securely held by the clasping mechanism 1066. In the event that a vehicle hits the elongate member 1030, the hingedly connected second portion 1065b rotates relative to the first portion 1065a. In another embodiment, the second portion 1065b is pivotably connected to the first portion 1065a. In the embodiment shown, the second portion 1065b is rotatable around an axis (in FIG. 10e-f, the axis is the rod or bolt connecting the elongate member 1030 to the first portion 1065a and second portion 1065b). As shown in FIG. 10f, the elongate member 1030 is affixed to the second portion 1065b. This advantageously alleviates the problem of both the vehicle being damaged and the portable boom gate apparatus 1000 being damaged. FIG. 10e shows a view of the portable boom gate apparatus 1000 with an elongate member in the STOP configuration and FIG. 10f shows the action of the second portion 1065b when force is applied to the elongate member 1030 (crash configuration). The crash configuration is when the second portion 1065b is not in the same plane or axis as the first portion 1065a. In an embodiment, the crash configuration comprises the second portion 1065b at about a 90° angle relative to the axis of the first portion 1065a. Furthermore, when a vehicle comes into contact with the elongate member 1030, substantial force is removed from the vehicle. This causes less damage and is also less likely to cause glass damage. This is particularly advantageous as visibility of shatter glass can be a significant issue.

The portable boom gate apparatus 1000 may further comprise an object detection sensor 1070. The objection detection sensor 1070 is able to detect an object in close proximity thereto. In one embodiment, the object detection sensor 1070 is placed in vicinity of the second portion 1065b in the crash configuration. As such, the object detection sensor 1070 detects when a vehicle has hit the elongate member 1030.

The elongate member 1030 comprises LED lights 1035. LED lights 1035 provide further awareness to incoming motorists of the upcoming portable boom gate apparatus 1000. It will be appreciated that LED lights may be placed on any surface of the elongate member 1030.

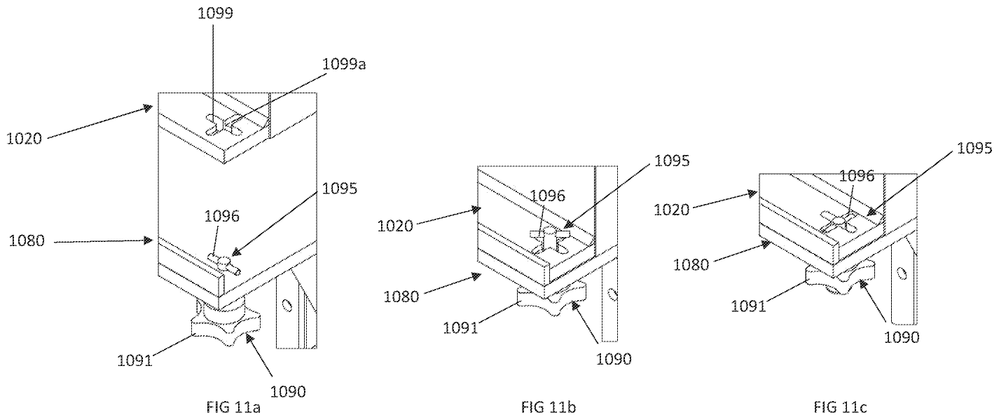

Shown in FIG. 11a-care enlarged views of the base 1080 and a lower end of the support member 1020. The base 1080 may be secured to the support member 1020 using a fastener. It will be appreciated that any fastener known in the art could be utilized to secure the base 1080 to the support member 1020. In one embodiment, the fastener comprises a screw device 1091 and an anchor device 1095. In one embodiment, the screw device 1090 comprises a handle 1091. In one embodiment, the handle is a star shaped handle. In an embodiment, the anchor device 1095 comprises an elongate anchoring member 1096 extending thereform.

The screw device 1090 comprises an externally threaded portion which cooperates with a threaded portion of anchor device 1095. The base 1080 comprises one or more apertures in which the externally threaded portion may be inserted therethrough. The threaded portion of the anchor device 1095 is then coupled with the externally threaded portion. The lower end of the support member 1020 comprises a shaped aperture 1099 that accommodates insertion of the elongate anchoring member 1096 (such as an aperture in the shape of the elongate anchoring member 1096) therethrough. The shaped aperture 1099 may be in communication with an indent which can retain the elongate anchoring member 1096 such that rotation thereof is prevented. In the embodiment shown, the aperture is in the form of a bar aperture 1099. The bar aperture 1099 may also be in communication with a bar shaped recess 1099a. In this regard, the elongate anchoring member 1096 may be inserted through the bar aperture 1099, and then retained in the bar shaped recess 1099a. As such, the handle 1091 can be turned to secure the base 1080 to the support member 1020.

The base 1080 comprises a battery holder 1085 which receives a battery. The battery holder 1085 is suitably dimensioned to retain a battery. The battery may be in addition to a battery in the support member 1020 or the battery may be attached to power the portable boom gate apparatus 1000. The base 1080 may also be adapted to be removably attached to part of a tray or may be removably attached to a tripod.

It will be appreciated that the tripod is suitably any tripod known in the art. The tripod is suitably a collapsible tripod assembly for mounting traffic signage and equipment. In one embodiment, the tripod assembly comprises: a central column having three or more brackets located along an outer surface of the column, and three leg assemblies such that each leg assembly is positioned between spaced apart side walls in a corresponding bracket and configured to pivot between a collapsed closed position and extended open position within side walls of the bracket.

The tripod assembly 1100 is suitable for use in supporting equipment including but not limited to traffic management equipment. The tripod assembly 1100 comprises a collapsible configuration. The tripod assembly 100 comprises a central column 1110 with a substantially cylindrical configuration with a circular cross-section. However, the shape and configuration of the central column 1110 is not limiting in any manner. Three brackets 1120 are circumferentially arranged along the outer wall of the central column 1110. Each bracket 1120 supports a pivotally coupled leg assembly 1130 that is configured to pivot (along pivot point 125) between a collapsed closed position and a plurality of stable extended open positions within side walls of the bracket 1120.

The bracket 1120 is structured to allow each leg assembly 1130 to pivot between a plurality of discrete extended open positions and the collapsed closed position. In each of the discrete open positions the leg assembly 1130 is oriented at a corresponding angular inclination relative to the central column

Each bracket 1120 comprises a first channel 1124 for positioning the leg assembly in the collapsed closed position: a second channel 1126 for positioning the leg assembly in the plurality of extended open positions. The pivoting arrangement in the form of the pivot pin 1125 is located in between the first and second channels 1124 and 1126 to allow the leg assembly to easily pivot between the first channel 1124 and the second channel 1126. Both the channels 1124 and 1126 are bound by parallel and spaced apart side walls 1127 that are sufficiently spaced apart for accommodating the leg assembly 1130. The first channel 1124 extends in a direction that is substantially parallel to the longitudinal central axis of the central column 1110 and the second channel 1126 extends in a transverse and preferably downwardly direction relative to the longitudinal central axis of the central column 1110.

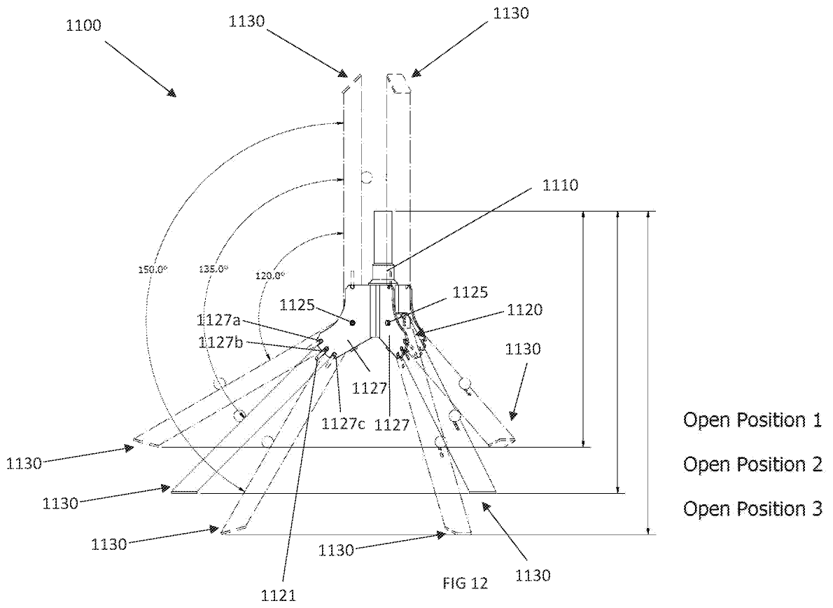

The side walls 1127 defining the first and second channels 1124 and 1126 may include a plurality of slots located along an imaginary arc of an imaginary circle with a centre point located substantially at the pivoting axis of the leg assembly 1130. The slots are structured to receive engagement structures. A locking arrangement is also provided for locking and retaining the engagement structures in the plurality in each discrete open position. In the preferred embodiment, the locking arrangement comprises a biasing member for applying a resilient bias on the engagement structures 1121 and thereby retain the engagement structures 1121 in at least one of said slots. Each leg assembly 1130 includes a leg member with a hollow configuration adapted to receive an attachment post for facilitating attachment of the leg assembly 1130 with the bracket 1120. The engagement structure 1121 is coupled with the attachment post such that axial movement of the attachment post along the length of the hollow leg member in a direction away from the bracket 1120 results in the engagement structure 1121 becoming uncoupled from one or more of said slots. Shown in FIG. 12 is an enlarged view of the tripod assembly 1100 in a number of positions, such as a closed position and a number of open positions (Open Position 1, Open Position 2 and Open Position 3). As shown, the spaced apart side walls 1127 comprise one or more slots 1127a, 1127b, 1127c. Each of the slots 1127a, 1127b, 1127c define an open position. The slots 1127a, 1127b, 1127c are structured and dimensioned to receive engagement structures 1121. Each leg assembly 1130 comprise a locking arrangement that is provided for locking and retaining the engagement structures 1121 in one of slots 1127a, 1127b, 1127c. In the embodiment shown, the locking arrangement comprises a biasing member for applying a resilient bias on the engagement structure 1121 and thereby retain the engagement structures 1121 in one of the said slots. As shown, depending on which slot is engaged, the angle and thus height of each leg assembly 1130 may be adjusted. Although the depicted embodiment comprises three open positions, the person skilled in the art will appreciate that any number of open positions may be provided by simply including further slots.

Advantageously, the tripod assembly allows for the boom gate apparatus and/or portable traffic signal assembly to be easily transported. Furthermore, the adjustability of each leg assembly allows for unpredictable terrain to be addressed. In this regard, depending on the topography of the terrain, each leg assembly can be adjusted accordingly. Furthermore, the tripod assembly also allows for the height of the boom gate apparatus or the traffic signal assembly to be adjusted.

Advantageously, the biasing member at one end is coupled with an upper portion of the attachment post and at an opposite end is coupled with the pivoting arrangement 1125 such that when the attachment post undergoes the axial movement away from the bracket, the biasing member resists such movement. As a result, in the absence of any force being applied on the attachment post, the engagement structure 1121 remains resiliently pushed and locked into one of the plurality of slots. The attachment post 1134 comprises a holding member 1137 projecting outwardly from an elongate slot located along an outer wall of the leg member such that movement of the holding member along the elongate slot of the leg member 1132 which allows a user to grab the holding member 1137 and effect downward movement of the attachment post in the axial direction by overcoming the biasing force of the biasing member ultimately resulting in the engagement structure 1121 becoming uncoupled from one of the slots of the side walls of the bracket 1120. For a user to change the angular orientation of the leg assembly 1130 by either pivoting the leg assembly 1130 from one of the open positions to the closed position or by pivoting the leg assembly 1130 from the closed position to one of the open position or to pivot the leg assembly 1130 from one open position to another open position, the user would need to grab the holding member and push the holding member along the elongate slot to overcome the biasing force which then unlocks the leg assembly 1130 (since the engagement structure 1121 is dislodged from one of the slots 1123) and allows the user to pivot the leg assembly 1130 to a desired position.

The tripod is described in Australian provisional patent application No. 2020903173, the contents of which is incorporated herein by reference.

In one embodiment, the elongate member and/or second elongate member may comprise one more additional features. Non-limiting examples of additional features these include signage, lights and/or detectors. These additional features may be removably attachable to the elongate member and/or second elongate member. Non-limiting examples of the signage include a STOP sign, a SLOW DOWN sign, or a ROADWORKS sign. The signage allows for the elongate member to be more visible to a motorist, and can also convey the reason for the obstruction. Non-limiting examples of the lights may include LED lights and neon lights. The lights make the elongate member to be more visible to the motorist. This is particularly advantageous in low light conditions. A non-limiting example of the detector is a vehicle detection sensor. The vehicle detection sensor informs the operator of a vehicle waiting in the queue. The detector may be in wireless communication with the remote control and send a signal when a vehicle is detected.

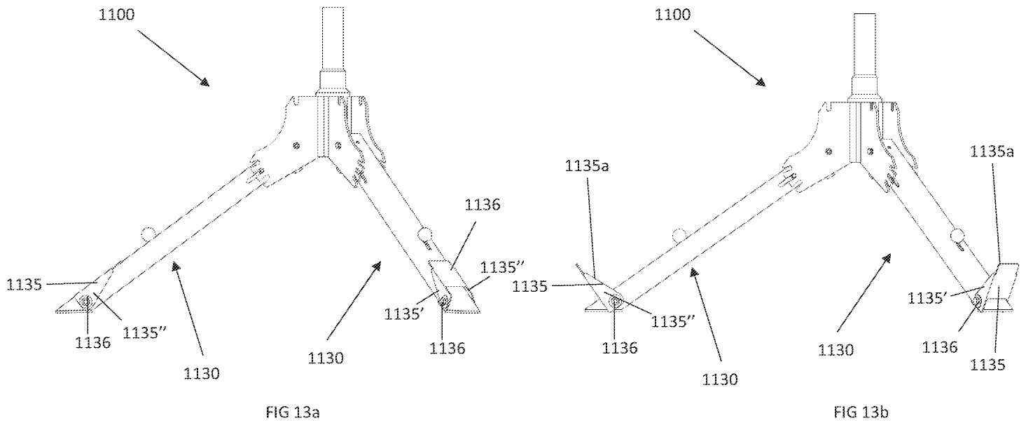

In one embodiment, the tripod assembly may further comprise one or more sandbag engaging members. Shown in FIG. 13a-b are an embodiment of the tripod assembly 1100. For the ease of description, the tripod assembly 1100 is as substantially described hereinabove in relation to FIG. 12 with a difference being that the present tripod assembly comprises sandbag engaging members. As shown in FIG. 13a-b, each leg assembly 1130 comprises a sandbag engaging member 1135. The sandbag engaging member 1135 is adapted to engage a sandbag. In one embodiment, each leg assembly 1130 comprises at least one sandbag engaging member 1135 at a distal end thereof.

As shown, the sandbag engaging members 1135 are suitably pivotable connected to the leg assembly 1130. The sandbag engaging member 1135 is preferably connected to the leg assembly 1130 by a pivoting arrangement in the form of the pivot pin 1136. The sandbag engaging member 1136 is pivotable between at least a storage configuration (shown in FIG. 13a) and a sandbag engaging configuration (shown in FIG. 13b). The sandbag engaging member 1135 suitably comprises member 1135a that engages the sandbag. In one embodiment, the member 1135 comprises a substantially flat surface that engages a sandbag. The sand bag engaging member 1135 may further include reinforcing walls 1135′, 1135″ to provide structural strength thereto. The reinforcing walls 1135′, 1135″ extend away from ends of member 1135a. The reinforcing walls 1135′, 1135″ extend away in the same direction from the member 1135a. The reinforcing walls 1135′, 1135″ are substantially perpendicular to the member 1135a. The reinforcing walls 1135a, 1135″ are connected to the leg assembly by the pivoting arrangement. In one embodiment, the sandbag engaging members 1135 are pivotable to engage the ground and a sandbag. In another embodiment the sandbag engaging members 1135 are pivotable such that they are maintained in a position above the ground. In this embodiment (e.g., as shown in FIG. 13b), the sandbag engaging member 1135 suitably do not engage the ground but are able to engage a sandbag to maintain the position of the tripod assembly to the ground.

In order to alleviate the issue of the tripod assembly and thus the portable boom gate apparatus from tipping over, the sandbag engaging members can be utilized with sandbags to further anchor the tripod assembly and the portable boom gate apparatus to the ground. Typically, tripods are utilized with sandbags by simply placing the sandbags over the legs thereof. However, sandbags may tend to slip off the legs of the tripod and the tripod may be more susceptible to tipping.

The invention also resides in a method of operating a portable boom gate apparatus, the method including the steps of:

providing a portable boom gate apparatus comprising a support member having an attachment portion, an elongate member pivotably connected to the support member, and an actuator adapted to pivot the elongate member;

attaching a second elongate member to the first elongate member; and

configuring the portable boom gate apparatus in an operable mode between a GO configuration and a STOP configuration,

to thereby operate the boom gate apparatus.

The portable boom gate apparatus is as substantially described hereinabove.

The method may further include a step of attaching the attachment portion to a second attachment portion on a tray. This step of attaching the attachment portion to the second attachment portion may be completed before attaching the second elongate member.

The method may further include the step of locating the portable boom gate apparatus adjacent a road.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this invention is intended to embrace all alternatives, modifications and variations of the present invention that have been discussed herein, and other embodiments that fall within the spirit and scope of the above described invention.

1-24. (canceled)

25. A portable boom gate apparatus comprising:
a support member having an attachment portion;
an elongate member pivotably connected to the support member; and
an actuator adapted to pivot the elongate member.

26. The portable boom gate apparatus of claim 25, wherein the actuator is adapted to pivot the elongate member to a GO configuration, a STOP configuration or a storage configuration.

27. The portable boom gate apparatus of claim 25, wherein the attachment portion is complementary to a second attachment portion, and wherein a tray comprises the second attachment portion.

28. The portable boom gate apparatus of claim 27, wherein a vehicle comprises the tray.

29. The portable boom gate apparatus of claim 28, wherein the tray is integrated with the vehicle or removably attachable to the vehicle.

30. The portable boom gate apparatus of claim 25, wherein the elongate member comprises a first securing portion, and wherein the portable boom gate apparatus further comprising a second elongate member comprising a second securing portion, wherein the second securing portion is complementary to the first securing portion.

31. The portable boom gate apparatus of claim 30, wherein the second elongate member is removably attachable to the elongate member.

32. The portable boom gate apparatus of claim 25, wherein the tray comprises a frame pivotably attached thereto.

33. The portable boom gate apparatus of claim 32, wherein the support member is removably attachable to a distal end of the frame.

34. The portable boom gate apparatus of claim 25, wherein the support member further comprises a handle.

35. The portable boom gate apparatus of claim 25, wherein the elongate member is removably attachable to a receiving member connected to the actuator.

36. The portable boom gate apparatus of claim 35, wherein the receiving member comprises a second portion hingedly connected to the first portion, wherein the first portion connects the actuator to the second portion.

37. The portable boom gate apparatus of claim 36, wherein the first portion comprises a first connecting portion that is complementary to a second connecting portion of the second portion, wherein the first and second connecting portions retain the first portion and the second portion in substantially the same axis.

38. The portable boom gate apparatus of claim 37, wherein application of force on the second portion results in rotation of the second portion relative to the first portion.

39. A portable traffic management system comprising:
a portable boom gate apparatus of claim 25; and
a portable traffic signal assembly.

40. The portable boom gate apparatus of claim 25, further comprising a remote control.

41. The portable boom gate apparatus of claim 40, wherein the remote control is in wireless communication with the portable boom gate apparatus and/or a portable traffic signal assembly.

42. The portable boom gate apparatus of claim 40, wherein the remote control is configured to send a GO configuration signal, a STOP configuration signal or a storage configuration signal to the portable boom gate apparatus or a GO configuration signal or STOP configuration signal to a portable traffic signal assembly.

43. A method of operating a portable boom gate apparatus, the method including the steps of:
providing a portable boom gate apparatus comprising a support member having an attachment portion, an elongate member pivotably connected to the support member, and an actuator adapted to pivot the elongate member;
attaching a second elongate member to the first elongate member; and
configuring the portable boom gate apparatus in an operable mode between a GO configuration and a STOP configuration,
to thereby operate the boom gate apparatus.
